(19) United States
(12) Patent Application Publication
(10) Pub. No.: US 2025/0081219 A1
(43) Pub. Date: Mar. 6, 2025

(54) CONFIGURATION ASSOCIATED WITH MULTI-CARRIER SWITCHING

(71) Applicant: QUALCOMM Incorporated, San Diego, CA (US)

(72) Inventors: Jing LEI, San Diego, CA (US); Kazuki TAKEDA, Minato-ku (JP); Kianoush HOSSEINI, San Diego, CA (US)

(21) Appl. No.: 18/459,344

(22) Filed: Aug. 31, 2023

(51) Int. Cl. H04W 72/51; H04W 72/0457; H04W 72/232; H04W 76/20

(52) U.S. Cl. CPC H04W 72/51; H04W 72/0457; H04W 72/232; H04W 76/20

(57) ABSTRACT

Various aspects of the present disclosure generally relate to wireless communication. In some aspects, a user equipment (UE) may transmit capability information that indicates a first quantity of carriers that the UE is capable of using simultaneously. The UE may receive a configuration for a second quantity of activated carriers. The UE may switch one or more carriers used for multi-carrier transmission based at least in part on the configuration and the capability information. Numerous other aspects are described.

### FIELD OF THE DISCLOSURE

Aspects of the present disclosure generally relate to wireless communication and to techniques and apparatuses for configuring multi-carrier switching.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting capability information that indicates a first quantity of carriers that the UE is capable of using simultaneously. The method may include receiving a configuration for a second quantity of activated carriers. The method may include switching one or more carriers used for multi-carrier transmission based at least in part on the configuration and the capability information.

Some aspects described herein relate to a method of wireless communication performed by a UE. The method may include receiving, for a radio resource control (RRC) connected mode, a window configuration for a multi-carrier switching window during which multiple carriers are used simultaneously and switched periodically. The method may include switching carriers within the multi-carrier switching window based at least in part on the window configuration and a UE capability.

Some aspects described herein relate to a method of wireless communication performed by a UE. The method may include receiving, for an RRC connected mode, a configuration for control resource sets and physical downlink control channel (PDCCH) search space sets associated with multiple carriers that are used simultaneously and switched periodically. The method may include monitoring the PDCCH search space sets on the control resource sets based at least in part on the configuration and a UE capability.

Some aspects described herein relate to a method of wireless communication performed by a network entity. The method may include receiving capability information that indicates a first quantity of carriers that a UE is capable of using simultaneously. The method may include transmitting a configuration for a second quantity of activated carriers. The method may include scheduling communications for multiple carriers based at least in part on the configuration and the capability information.

Some aspects described herein relate to an apparatus for wireless communication at a UE. The apparatus may include one or more memories and one or more processors coupled to the one or more memories. The one or more processors may be individually or collectively configured to cause the UE to transmit capability information that indicates a first quantity of carriers that the UE is capable of using simultaneously. The one or more processors may be individually or collectively configured to cause the UE to receive a configuration for a second quantity of activated carriers. The one or more processors may be individually or collectively configured to cause the UE to switch one or more carriers used for multi-carrier transmission based at least in part on the configuration and the capability information.

Some aspects described herein relate to an apparatus for wireless communication at a UE. The apparatus may include one or more memories and one or more processors coupled to the one or more memories. The one or more processors may be individually or collectively configured to cause the UE to receive, for an RRC connected mode, a window configuration for a multi-carrier switching window during which multiple carriers are used simultaneously and switched periodically. The one or more processors may be individually or collectively configured to cause the UE to switch carriers within the multi-carrier switching window based at least in part on the window configuration and a UE capability.

Some aspects described herein relate to an apparatus for wireless communication at a UE. The apparatus may include one or more memories and one or more processors coupled to the one or more memories. The one or more processors may be individually or collectively configured to cause the UE to receive, for an RRC connected mode, a configuration for control resource sets and PDCCH search space sets associated with multiple carriers that are used simultaneously and switched periodically. The one or more processors may be individually or collectively configured to cause the UE to monitor the PDCCH search space sets on the control resource sets based at least in part on the configuration and a UE capability.

Some aspects described herein relate to an apparatus for wireless communication at a network entity. The apparatus may include one or more memories and one or more processors coupled to the one or more memories. The one or more processors may be individually or collectively configured to cause the network entity to receive capability information that indicates a first quantity of carriers that a UE is capable of using simultaneously. The one or more processors may be individually or collectively configured to cause the network entity to transmit a configuration for a second quantity of activated carriers. The one or more processors may be individually or collectively configured to cause the network entity to schedule communications for multiple carriers based at least in part on the configuration and the capability information.

Some aspects described herein relate to a non-transitory computer-readable medium that stores a set of instructions for wireless communication by a UE. The set of instructions, when executed by one or more processors of the UE, may cause the UE to transmit capability information that indicates a first quantity of carriers that the UE is capable of using simultaneously. The set of instructions, when executed by one or more processors of the UE, may cause the UE to receive a configuration for a second quantity of activated carriers. The set of instructions, when executed by one or more processors of the UE, may cause the UE to switch one or more carriers used for multi-carrier transmission based at least in part on the configuration and the capability information.

Some aspects described herein relate to a non-transitory computer-readable medium that stores a set of instructions for wireless communication by a UE. The set of instructions, when executed by one or more processors of the UE, may cause the UE to receive, for an RRC connected mode, a window configuration for a multi-carrier switching window during which multiple carriers are used simultaneously and switched periodically. The set of instructions, when executed by one or more processors of the UE, may cause the UE to switch carriers within the multi-carrier switching window based at least in part on the window configuration and a UE capability.

Some aspects described herein relate to a non-transitory computer-readable medium that stores a set of instructions for wireless communication by a UE. The set of instructions, when executed by one or more processors of the UE, may cause the UE to receive, for an RRC connected mode, a configuration for control resource sets and

PDCCH search space sets associated with multiple carriers that are used simultaneously and switched periodically. The set of instructions, when executed by one or more processors of the UE, may cause the UE to monitor the PDCCH search space sets on the control resource sets based at least in part on the configuration and a UE capability.

Some aspects described herein relate to a non-transitory computer-readable medium that stores a set of instructions for wireless communication by a network entity. The set of instructions, when executed by one or more processors of the network entity, may cause the network entity to receive capability information that indicates a first quantity of carriers that a UE is capable of using simultaneously. The set of instructions, when executed by one or more processors of the network entity, may cause the network entity to transmit a configuration for a second quantity of activated carriers. The set of instructions, when executed by one or more processors of the network entity, may cause the network entity to schedule communications for multiple carriers based at least in part on the configuration and the capability information.

Some aspects described herein relate to an apparatus for wireless communication. The apparatus may include means for transmitting capability information that indicates a first quantity of carriers that the apparatus is capable of using simultaneously. The apparatus may include means for receiving a configuration for a second quantity of activated carriers. The apparatus may include means for switching one or more carriers used for multi-carrier transmission based at least in part on the configuration and the capability information.

Some aspects described herein relate to an apparatus for wireless

communication. The apparatus may include means for receiving, for an RRC connected mode, a window configuration for a multi-carrier switching window during which multiple carriers are used simultaneously and switched periodically. The apparatus may include means for switching carriers within the multi-carrier switching window based at least in part on the window configuration and an apparatus capability.

Some aspects described herein relate to an apparatus for wireless communication. The apparatus may include means for receiving, for an RRC connected mode, a configuration for control resource sets and PDCCH search space sets associated with multiple carriers that are used simultaneously and switched periodically. The apparatus may include means for monitoring the PDCCH search space sets on the control resource sets based at least in part on the configuration and an apparatus capability.

Some aspects described herein relate to an apparatus for wireless communication. The apparatus may include means for receiving capability information that indicates a first quantity of carriers that a UE is capable of using simultaneously. The apparatus may include means for transmitting a configuration for a second quantity of activated carriers. The apparatus may include means for scheduling communications for multiple carriers based at least in part on the configuration and the capability information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features May include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of carrier aggregation, in accordance with the present disclosure.

FIGS. 5A-5C are diagrams illustrating examples of full duplex communication in accordance with the present disclosure.

FIG. 6 is a diagram illustrating an examples of multi-carrier spectrum, in accordance with the present disclosure.

FIG. 7 is a diagram illustrating an example associated with configuring multi-carrier (MC) switching, in accordance with the present disclosure.

FIG. 8 is a diagram illustrating an examples of MC switching, in accordance with the present disclosure.

FIG. 9 is a diagram illustrating an example of MC switching windows, in accordance with the present disclosure.

FIG. 10 is a diagram illustrating an example associated with MC switching, in accordance with the present disclosure.

FIG. 11 is a diagram illustrating an example resource structure for wireless communication, in accordance with the present disclosure.

FIG. 12 is a diagram illustrating an example associated with MC switching, in accordance with the present disclosure.

FIG. 13 is a diagram illustrating an example process performed, for example, at a UE or an apparatus of a UE, in accordance with the present disclosure.

FIG. 14 is a diagram illustrating an example process performed, for example, at a UE or an apparatus of a UE, in accordance with the present disclosure.

FIG. 15 is a diagram illustrating an example process performed, for example, at a UE or an apparatus of a UE, in accordance with the present disclosure.

FIG. 16 is a diagram illustrating an example process performed, for example, at a network entity or an apparatus of a network entity, in accordance with the present disclosure.

FIG. 17 is a diagram of an example apparatus for wireless communication, in accordance with the present disclosure.

FIG. 18 is a diagram of an example apparatus for wireless communication, in accordance with the present disclosure.

### DETAILED DESCRIPTION

In some aspects, a network entity and a user equipment (UE) may perform multi-carrier (MC) switching on unpaired spectrum for a UE (e.g., a sixth generation (6G) UE) with limited carrier aggregation (CA) capabilities. MC switching may include communication on a first set of multiple carriers and then switching to a second set of multiple carriers. Some carriers in the first set may or may not be included in the second set. MC switching may improve the coverage, the latency, and/or the throughput of a UE and improve the resource utilization efficiency of unpaired spectrum.

However, there are various types of UEs that can perform MC switching, including reduced capability (RedCap) UEs that do not support dual connectivity (DC) or CA, and CA-capable UEs that are configured with a quantity of carriers that exceed the UE capability of the CA-capable UEs. If a UE is not configured with an appropriate level of carrier switching, the UE may drop communications, which increases latency and reduces throughput.

According to various aspects described herein, a UE may indicate its capability for using multiple carriers and switch carriers based on its capability and a configuration for available carriers. For example, the UE may transmit capability information that indicates a first quantity of carriers that the UE is capable of using simultaneously. Simultaneous use may include carriers that overlap in time and may not necessarily start or end use at the same time. The first quantity of carriers may include a quantity of downlink carriers or a quantity of uplink carriers. The UE may also receive a configuration for a second quantity of activated carriers. The second quantity of activated carriers may include a quantity of downlink carriers that are available or a quantity of uplink carriers that are available. The UE may switch one or more carriers used for MC transmission based at least in part on the configuration and the capability information. The second quantity may be equal to or greater than the first quantity.

By indicating a capability for multiple carriers and switching based on the capability and a received configuration for available carriers, the UE may optimize carriers to improve communications. As a result, latency is reduced and throughput is increased.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

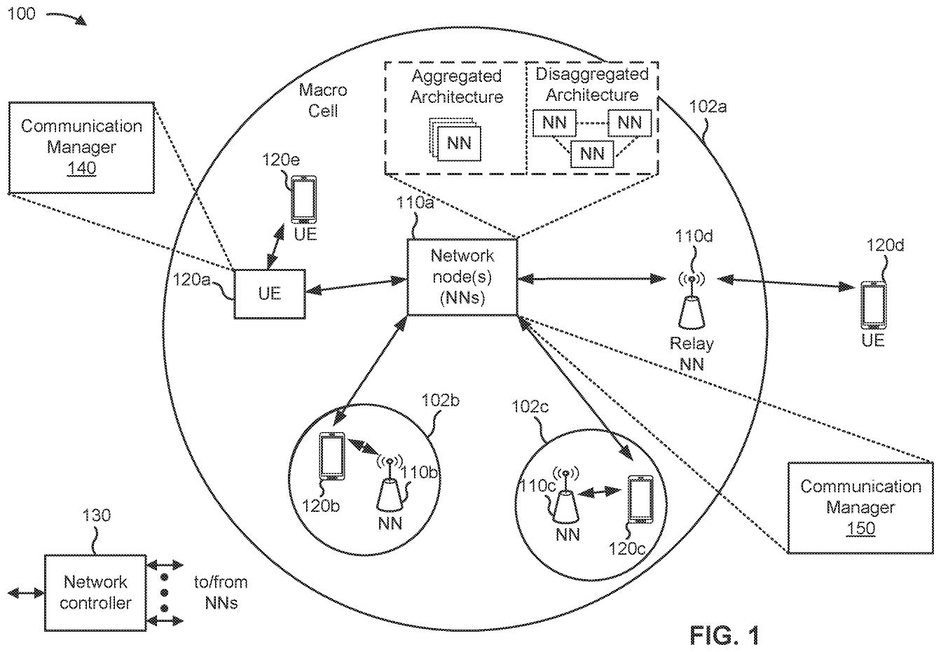

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network clement, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an cMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410MHz-7.125 GHz) and FR2 (24.25 GHz-52.6 GHZ). It should be understood that although a portion of FRI is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may transmit capability information that indicates a first quantity of carriers that the UE is capable of using simultaneously. The communication manager 140 may receive a configuration for a second quantity of activated carriers. The communication manager 140 may switch one or more carriers used for MC transmission based at least in part on the configuration and the capability information.

In some aspects, the communication manager 140 may receive, for a radio resource control (RRC) connected mode, a window configuration for an MC switching window during which multiple carriers are used simultaneously and switched periodically. The communication manager 140 may switch carriers within the MC switching window based at least in part on the window configuration and a UE capability.

In some aspects, the communication manager 140 may receive, for an RRC connected mode, a configuration for control resource sets and physical downlink control channel (PDCCH) search space sets associated with multiple carriers that are used simultaneously and switched periodically. The communication manager 140 may monitor the PDCCH search space sets on the control resource sets based at least in part on the configuration and a UE capability. Additionally, or alternatively, the communication manager 140 may perform one or more other operations described herein.

In some aspects, a network entity (e.g., a network node 110) may include a communication manager 150. As described in more detail elsewhere herein, the communication manager 150 may receive capability information that indicates a first quantity of carriers that a UE is capable of using simultaneously. The communication manager 150 may transmit a configuration for a second quantity of activated carriers. The communication manager 140 may schedule communications for multiple carriers based at least in part on the configuration and the capability information. Additionally, or alternatively, the communication manager 150 may perform one or more other operations described herein.

As indicated above, FIG. 1 is provided as an example. Other examples may differ from what is described with regard to FIG. 1.

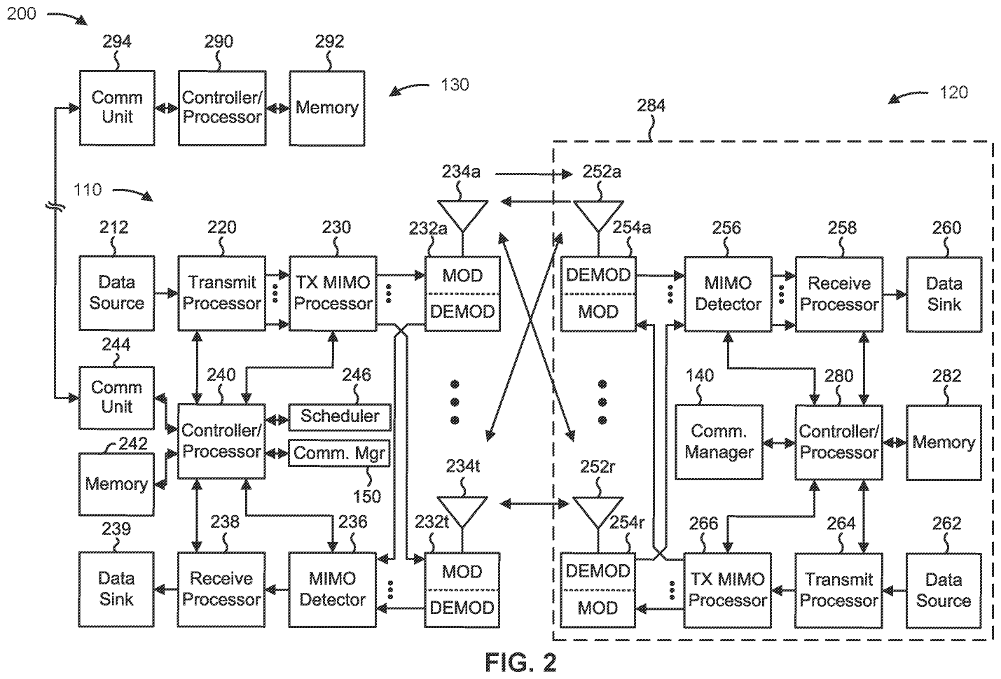

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal. A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

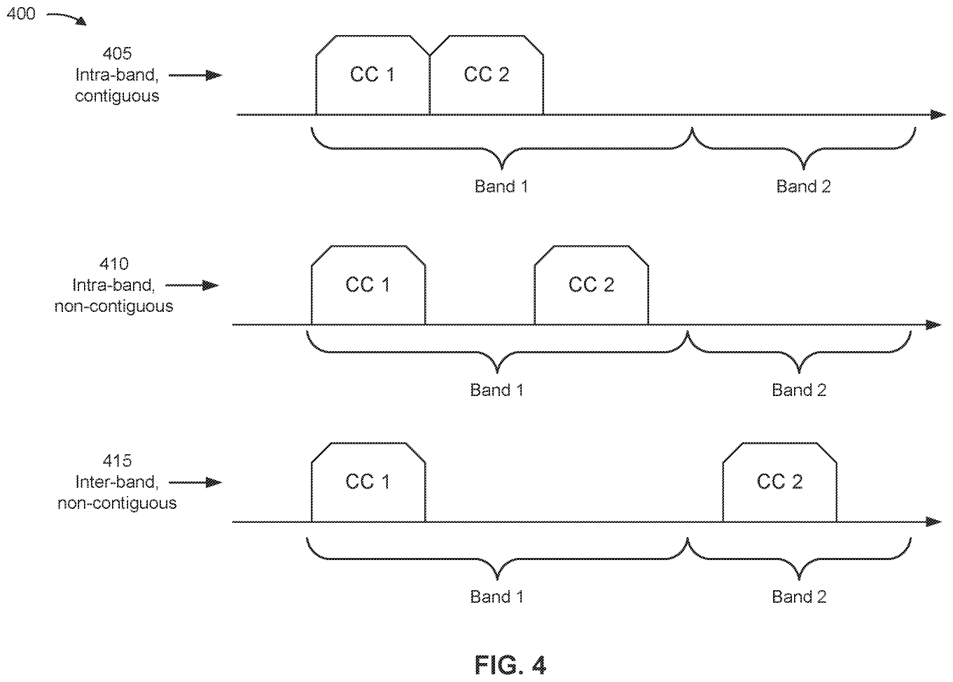

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-18).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-18).

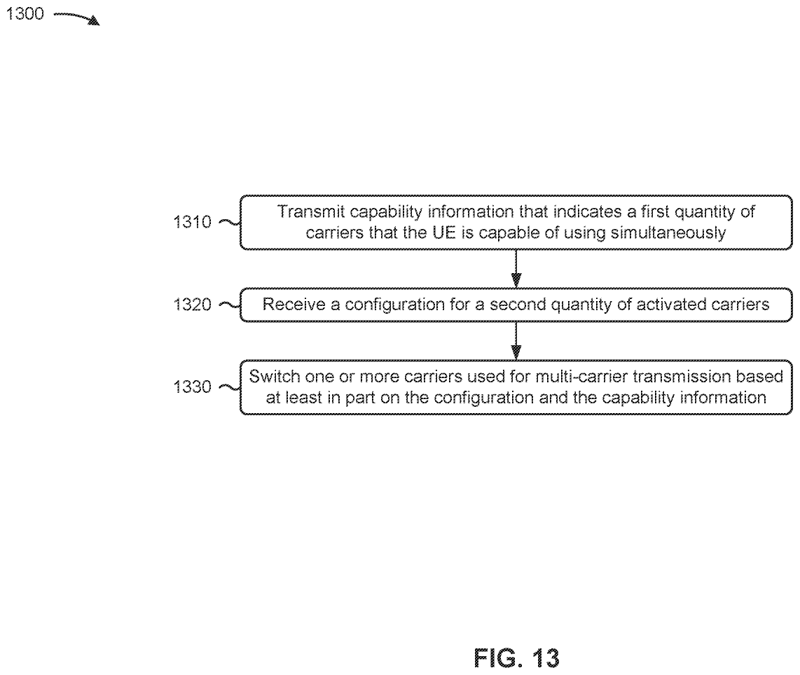

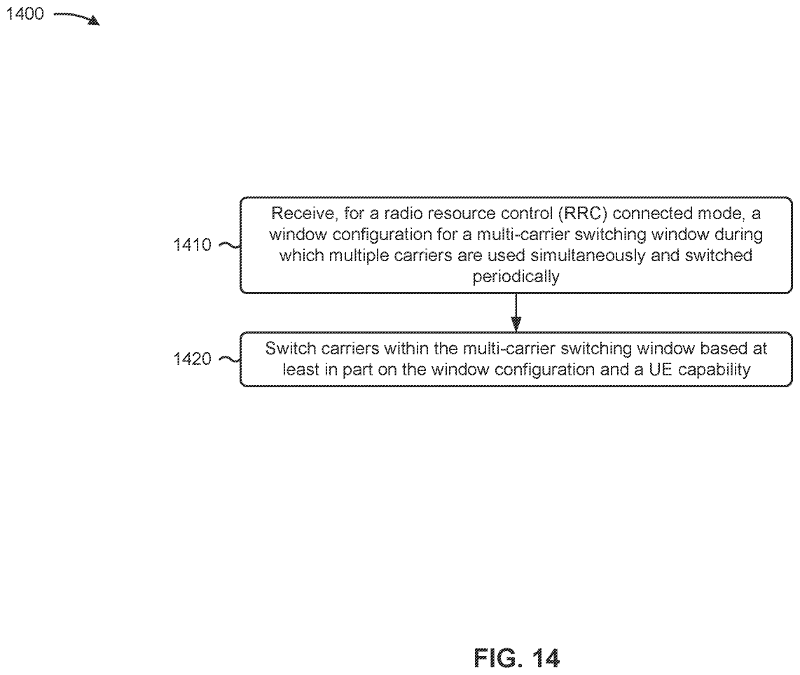

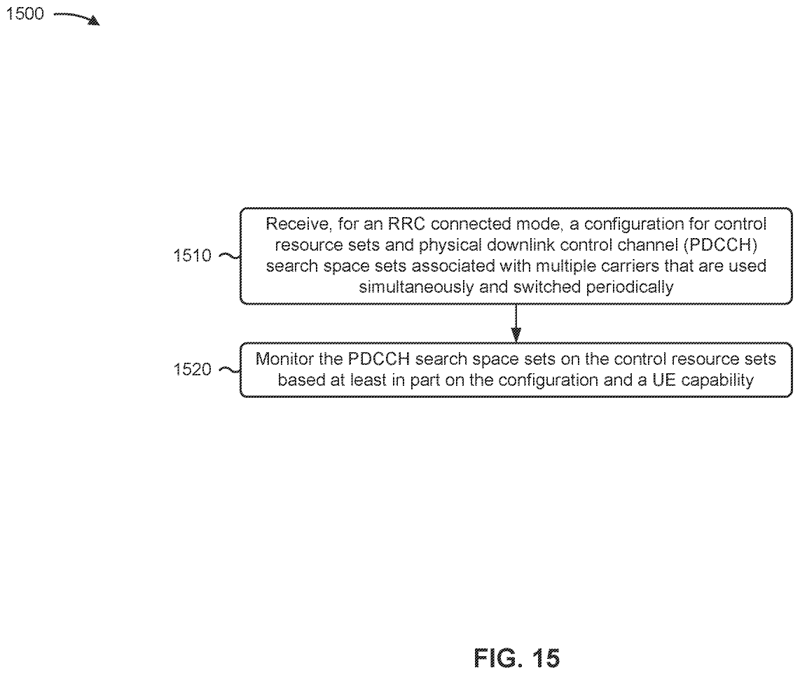

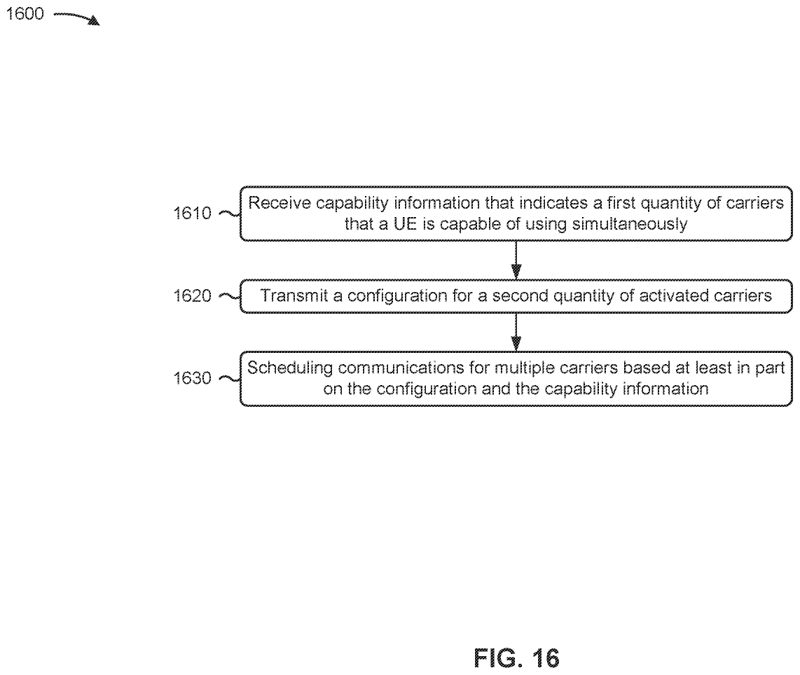

The controller/processor of a network entity (e.g., the controller/processor 240 of the network node 110), the controller/processor 280 of the UE 120, and/or any other component(s) of FIG. 2 may perform one or more techniques associated with configuring MC switching, as described in more detail elsewhere herein. For example, the controller/processor 240 of the network node 110, the controller/processor 280 of the UE 120, and/or any other component(s) of FIG. 2 may perform or direct operations of, for example, process 1300 of FIG. 13, process 1400 of FIG. 14, process 1500 of FIG. 15, process 1600 of FIG. 16, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1300 of FIG. 13, process 1400 of FIG. 14, process 1500 of FIG. 15, process 1600 of FIG. 16, and/or other processes as described herein. In some examples, executing instructions may include running the instructions, converting the instructions, compiling the instructions, and/or interpreting the instructions, among other examples.

In some aspects, a UE (e.g., a UE 120) includes means for transmitting capability information that indicates a first quantity of carriers that the UE is capable of using simultaneously; means for receiving a configuration for a second quantity of activated carriers; and/or means for switching one or more carriers used for MC transmission based at least in part on the configuration and the capability information.

In some aspects, the UE includes means for receiving. for an RRC connected mode, a window configuration for an MC switching window during which multiple carriers are used simultaneously and switched periodically; and/or means for switching carriers within the MC switching window based at least in part on the window configuration and a UE capability.

In some aspects, the UE includes means for receiving, for an RRC connected mode, a configuration for control resource sets and PDCCH search space sets associated with multiple carriers that are used simultaneously and switched periodically; and/or means for monitoring the PDCCH search space sets on the control resource sets based at least in part on the configuration and a UE capability. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a network node 110) includes means for receiving capability information that indicates a first quantity of carriers that a UE is capable of using simultaneously; means for transmitting a configuration for a second quantity of activated carriers; and/or means for scheduling communications for multiple carriers based at least in part on the configuration and the capability information. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

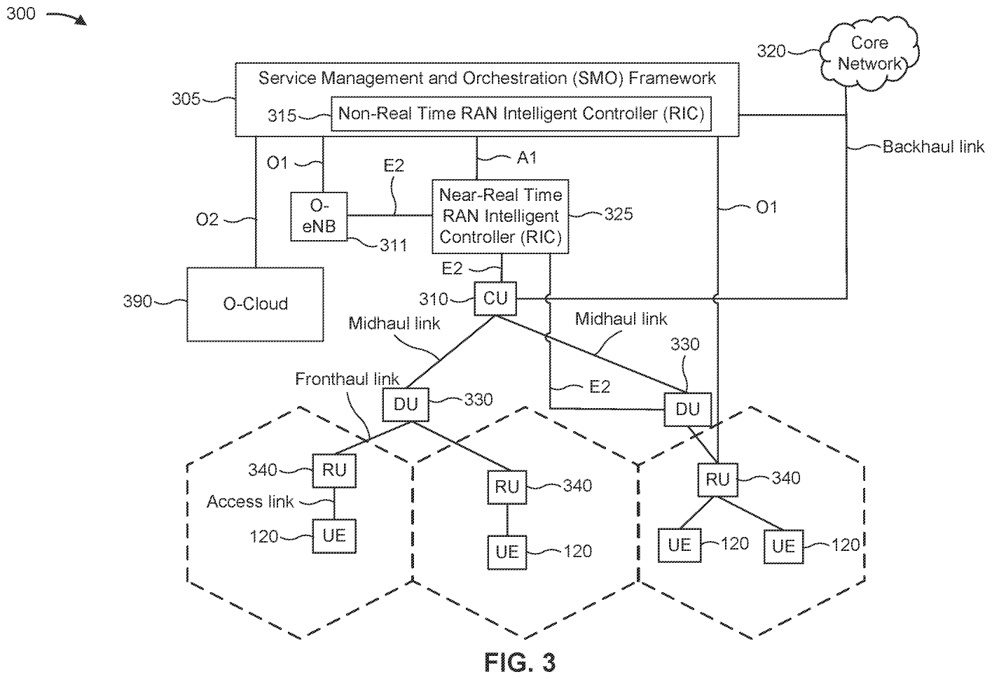

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 May communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

FIG. 4 is a diagram illustrating examples 400 of CA, in accordance with the present disclosure.

CA is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in an RRC message, downlink control information (DCI), and/or another signaling message.

As shown by reference number 405, in some aspects, CA may be configured in an intra-band contiguous mode where the aggregated carriers are contiguous to one another and are in the same band. As shown by reference number 410, in some aspects, CA may be configured in an intra-band non-contiguous mode where the aggregated carriers are non-contiguous to one another and are in the same band. As shown by reference number 415, in some aspects, CA may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

As indicated above, FIG. 4 is provided as an example. Other examples may differ from what is described with regard to FIG. 4.

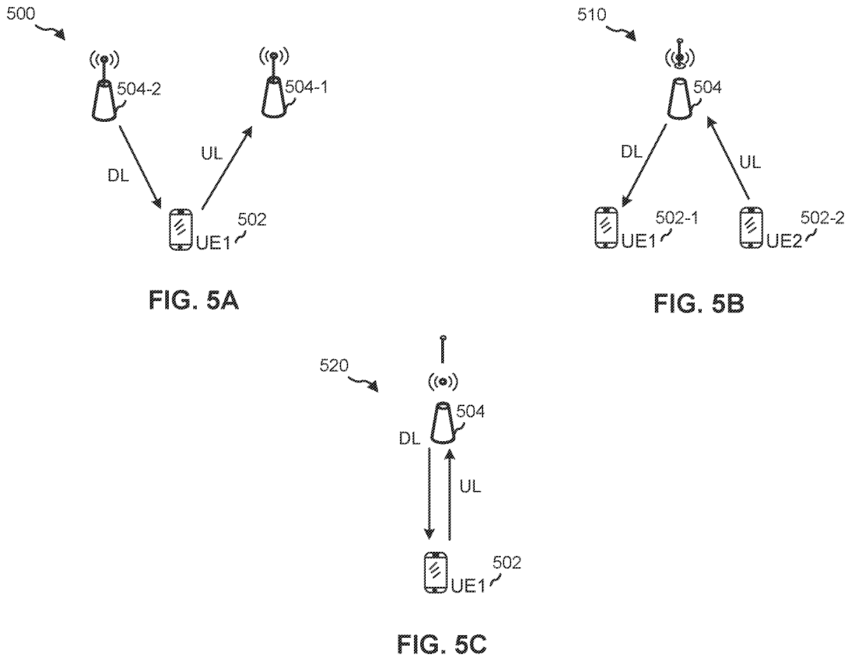

FIGS. 5A-5C are diagrams illustrating examples 500, 510, 520 of full duplex (FD) communication in accordance with the present disclosure. The example 500 of FIG. 5A includes a UE1 502 and two base stations (e.g., TRPs) 504-1, 504-2, where the UE1 502 is sending UL transmissions to base station 504-1 and is receiving downlink (DL) transmissions from base station 504-2. In the example 500 of FIG. 5A, FD is enabled for the UE1 502, but not for the base stations 504-1, 504-2. The example 510 of FIG. 5B includes two UEs, shown as UE1 502-1 and UE2 502-2, and a base station 504, where the UE1 502-1 is receiving a DL transmission from the base station 504 and the UE2 502-2 is transmitting an uplink (UL) transmission to the base station 504. In the example 510 of FIG. 5B, FD is enabled for the base station 504, but not for UE1 502-1 and UE2 502-2. The example 520 of FIG. 5C includes a UE1 502 and a base station 504, where the UE1 502 is receiving a DL transmission from the base station 504 and the UE1 502 is transmitting an UL transmission to the base station 504. In the example 520 of FIG. 5C, FD is enabled for both the UE1 502 and the base station 504.

As indicated above, FIGS. 5A-5C are provided as one or more examples. Other examples may differ from what is described with regard to FIGS. 5A-5C.

Some aspects of 5G and future techniques, such as in 6G, may include spectrum aggregation across existing and new frequency bands. For example, to enable enhanced services and better user experiences in 6G, a network entity may aggregate spectrum allocated in a new FR, re-farmed in FR1/2, or shared with another RAT. Spectrum aggregation may involve some amount of CA with multiple CCs in different spectrums. Accordingly, a UE with enhanced or limited CA capabilities may fuel ecosystem expansion in diverse deployments of 6G. UEs with limited CA capabilities may include low-end smartphones, wearables, IoT devices for a smart city, healthcare devices, and/or other devices for industry and enterprise. For a network with aggregated spectrum, MC operations can be tailored or adapted for different UE types to optimize tradeoffs, including tradeoffs among capacity, spectral efficiency, energy efficiency and latency.

In some aspects, a network entity and a UE may perform MC switching on unpaired spectrum for a 6G UE with limited CA capabilities. MC switching may include communication on a first set of multiple carriers and then switching to a second set of multiple carriers. Some carriers in the first set may or may not be included in the second set. MC switching may improve the coverage, the latency, and/or the throughput of a UE and improve the resource utilization efficiency of unpaired spectrum. However, there are various types of UEs that can perform MC switching, including RedCap UEs that do not support DC or CA, and CA-capable enhance mobile broadband (cMBB) UEs that are configured with a quantity of carriers that exceed the UE capability of the CA-capable eMBB UEs. If a UE is not configured with an appropriate level of carrier switching, the UE may drop communications, which increases latency and reduces throughput.

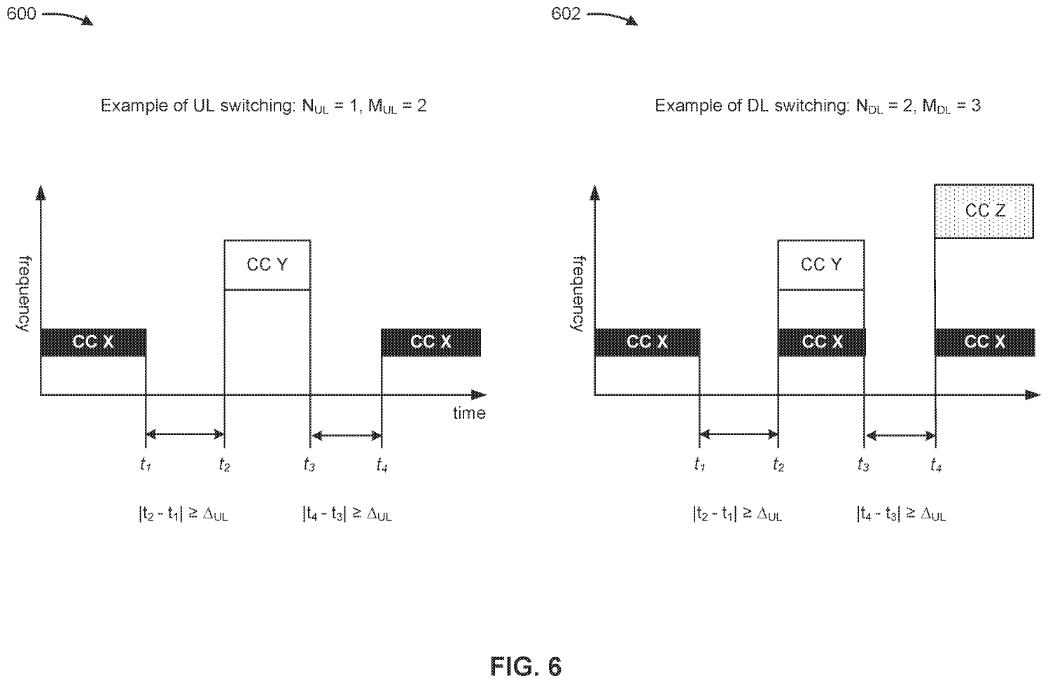

FIG. 6 is a diagram illustrating an examples 600 and 602 of MC spectrum, in accordance with the present disclosure.

According to various aspects described herein, a UE may indicate its capability for using multiple carriers and switch carriers based on its capability and a configuration for available carriers. For example, the UE may transmit capability information that indicates a first quantity of carriers that the UE is capable of using simultaneously. Simultaneous use may include carriers that overlap in time and may not necessarily start or end use at the same time. The first quantity of carriers may include a quantity N_{DL} of downlink carriers or a quantity N_{UL} of uplink carriers. The UE may also receive a configuration for a second quantity of activated carriers. The second quantity of activated carriers may include a quantity M_{DL} of downlink carriers that are available or a quantity M_{UL} of uplink carriers that are available. The UE may switch one or more carriers used for MC transmission based at least in part on the configuration and the capability information. The second quantity may be equal to or greater than the first quantity. By indicating a capability for multiple carriers and switching based on the capability and a received configuration for available carriers, the UE may optimize carriers to improve communications. As a result, latency is reduced and throughput is increased.

Example 600 shows an example of MC switching of UL carriers (CC X and CC Y). In this example, the UE is capable of transmitting on one carrier at a time (N_{UL}=1) out of an available two carriers (M_{UL}=2). The UL carriers may be in an unpaired spectrum. There may be a time gap (t₂−t₁) that is greater than or equal to a UE capability for switching carriers.

With MC switching on an UL, a UE capable of simultaneous transmission on at most N_{UL} (N_{UL}≥1) CCs can transmit data, control information, and/or a reference signal to its serving cell(s) on M_{UL} CCs, where M_{UL}≥N_{UL}. N_{UL} is a reported by the UE as a UE capability, while M_{UL} is configured by the network (e.g., in an RRC message or a MAC control element (MAC CE)). The M_{UL} CCs may operate in time division duplexing (TDD), including in subband full duplex (SBFD), a supplementary UL (SUL), or a combination thereof. SBFD may include transmission in both the UL and the DL during a slot.

In a slot configured as “UL” or “S” (for special slot that can be UL or DL), the UE may not be expected to transmit data, control information, and/or a reference signal on more than N_{UL} CCs. At two different time instants (e.g., T_{A,UL} and T_{B, UL}, where T_{A,UL}<T_{B, UL}) that the UE is configured for UL transmission, the components of the N_{UL} CCs may be the same or different. If the configuration of the N_{UL} CCs changes at T_{B, UL}, the UE may expect |T_{B, UL}−T_{A,UL}|≥Δ_{UL}, where Δ_{UL} denotes the minimum gap for MC switching for UL and Δ_{UL} is based at least in part on UE capabilities, the FR of MC configurations, the quantity of bands switched, and/or the type of MC switching (e.g., intra-band, inter-band, inter-FR).

Example 602 shows an example of MC switching of DL carriers (CC X, CC Y, and CC Z). In this example, the UE is capable of receiving on two carriers at a time (N_{DL}=2) out of an available two carriers (M_{DL}=3). The DL carriers may be in an unpaired spectrum.

With MC switching on the DL, a UE capable of simultaneous reception from at most N_{DL} (N_{DL}≥1) CCs may receive data, control information, and/or a reference signal from its serving cell(s) on M_{DL} CCs, where M_{DL}≥N_{DL}. N_{DL} is reported by the UE as a UE capability, while M_{DL} is configured by the network (e.g., in RRC or MAC CE). The M_{DL} CCs may operate in TDD (including SBFD), a supplementary DL (SDL), or a combination thereof.

In a slot configured as “DL” or “S”, the UE may not be expected to receive data, control information, and/or a reference signal on more than N_{DL} CCs. At two different time instants (say T_{A,DL} and T_{B,DL}, where T_{A,DL}<T_{B, DL}) that the UE is configured for DL reception, the N_{DL} CCs may be the same or different. If the configuration of the N_{DL} CCs changes at T_{B,DL}, the UE may expect |T_{B,DL}−T_{A,DL}|≥Δ_{DL}, where Δ_{DL} denotes the minimum gap for MC switching for DL, and Δ_{DL} may be based at least in part on UE capabilities, the FR of MC configurations, the quantity of bands switched, and/or the type of MC switching (e.g., intra-band, inter-band, inter-FR).

In some aspects, MC switching on the DL and the UL may be separately configured for the UE. In UE capability signaling, the UE may indicate whether the UE supports FD or half-duplex (HD) operation for MC switching on unpaired spectrum. A TDD carrier may be configured as one of the N_{DL} CCs on a DL slot, or configured as one of the N_{UL} CCs on an UL slot, or jointly configured for both DL and UL slots.

As indicated above, FIG. 6 is provided as an example. Other examples may differ from what is described with regard to FIG. 6.

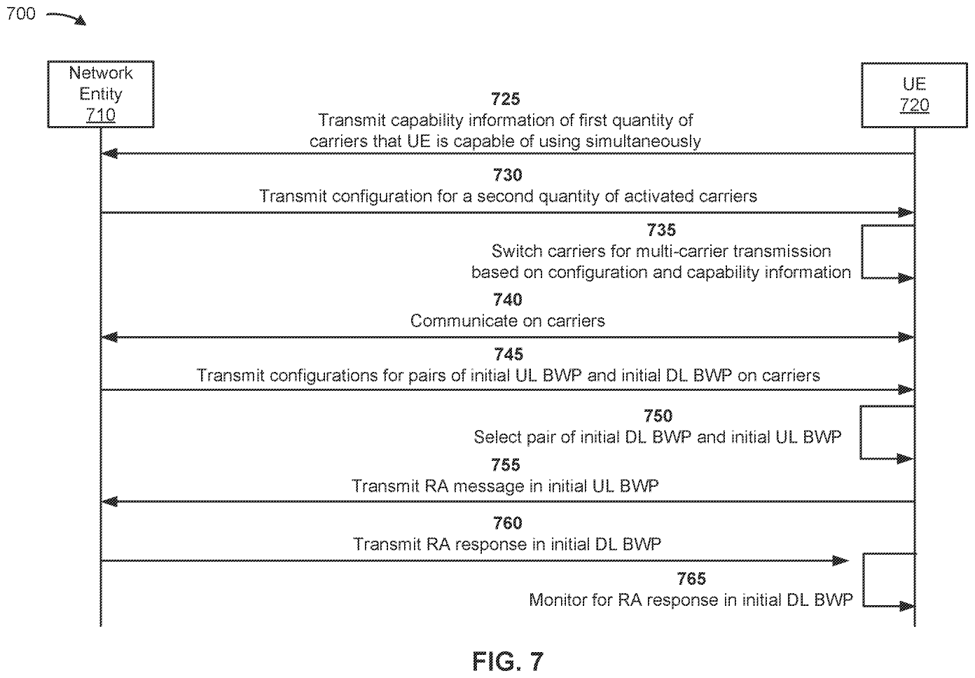

FIG. 7 is a diagram illustrating an example 700 associated with configuring MC switching, in accordance with the present disclosure. As shown in FIG. 7, a network entity 710 (e.g., network node 110) and a UE 720 (e.g., a UE 120) may communicate with one another in a wireless network (e.g., wireless network 100).

Example 700 shows the UE indicating a UE capability for carriers and switching. As shown by reference number 725, the UE 720 may transmit, and the network entity 710 may receive, capability information that indicates a first quantity of carriers that the UE is capable of using simultaneously. The capability information may include information about a capability for switching, such as a minimum time gap between carriers. The capability information may indicate whether the UE 710 supports FD operation on paired spectrum, unpaired spectrum, or for CA.

As shown by reference number 730, the network entity 710 may transmit, and the UE 720 may receive, a configuration for a second quantity of activated carriers. The activated carriers may be the carriers that are available for use by the UE 720 and may be the carriers among which the UE 720 may switch. The activated carriers may be for UL or DL.

As shown by reference number 735, the UE 720 may switch one or more carriers used for MC transmission based at least in part on the configuration and the capability information. For example, the UE 720 may select up to the first quantity of carriers from among the second quantity of carriers to improve communications. If channel conditions on one or more carriers drop below a threshold, the UE 720 may switch to other carriers. The UE 720 may not switch to a quantity of carriers that exceeds the first quantity of carriers. As shown by reference number 740, the UE 720 and the network node 710 may communicate on the carriers. The carriers may be for UL or DL.

In some aspects, the UE 720 may be configured with initial bandwidth parts (BWPs) in UL or DL and may perform a random access channel (RACH) procedure with the initial BWPs. In contrast with legacy designs in NR/5G, the network entity 710 may configure multiple pairs of initial DL/UL BWPs. Based at least in part on a UE capability and one or more measurements (e.g., RSRP measurements) for a downlink reference signal associated with carrier selection or BWP selection measurements, the UE may select one pair of initial DL/UL BWPs to perform the RACH procedure.

Example 700 shows this selection. As shown by reference number 745, the network entity 710 may transmit configurations for multiple pairs of an initial DL BWP and an initial UL BWP on one or more carriers. The UE 720 may receive the configurations. As shown by reference number 750, the UE 720 may select a pair of an initial DL BWP and an initial UL BWP based at least in part on a UE capability of the UE 720 and RSRP measurements of a downlink reference signal.

As shown by reference number 755, the UE 720 may transmit a random access (RA) message, and the network entity 710 may receive, in the initial uplink UL BWP. The RA message may be associated with a PRACH, a physical uplink shared channel (PUSCH), and/or a physical uplink control channel (PUCCH), which may be UL channels transmitted by the UE in the initial UL BWP. As shown by reference number 760, the network entity 710 may transmit an RA response in the initial DL BWP. As shown by reference number 765, the UE 720 may monitor for the RA response message in the initial DL BWP on one or more carriers selected for a RACH procedure. By using initial BWPs for the RACH messages, the UE 720 may reduce latency when multiple carriers are involved.

In some aspects, the initial DL BWP and the initial UL BWP may both be configured on only one CC. In some aspects, the initial DL BWP may be configured on only one CC, while the initial UL BWP may be configured on multiple CCs (e.g., as an extension of an SUL). In some aspects, the initial DL BWP and the initial UL BWP may be configured on multiple CCs, respectively (e.g., as extensions of an SDL and an SUL).

As indicated above, FIG. 7 is provided as an example. Other examples may differ from what is described with respect to FIG. 7.

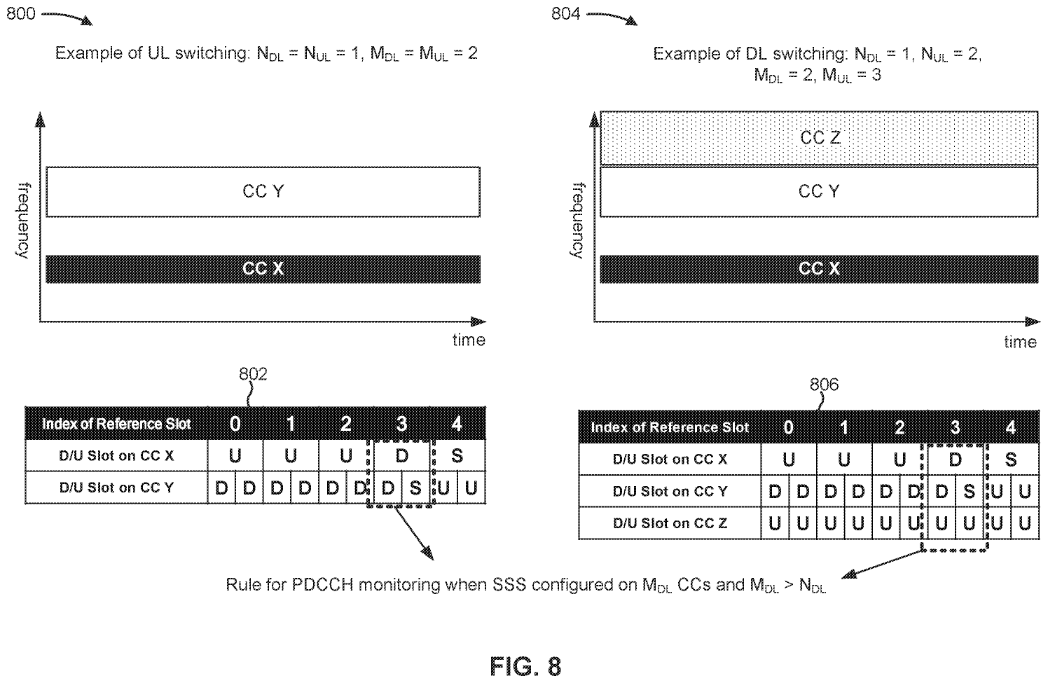

FIG. 8 is a diagram illustrating an examples 800 and 804 of MC switching, in accordance with the present disclosure.

Example 800 shows an example of MC switching for an FD-capable UE, where each of the carriers have a slot pattern, as shown by table 802. For example, in slot 3, the UE may switch from UL to DL on CC X. In example 800, the UE may switch to UL on CC Y in slot 4, and an S precedes slot 4 to allow for the UE to retune an antenna for transmission. In example 804, table 806 shows that the UE may switch to DL on CC X in slot 3 and to UL on CC Y in slot 4. An S precedes slot 4 to allow for the UE to retune an antenna for transmission.

In some aspects, a search space set (SSS) may be configured for a secondary cell. When CA is supported, a secondary cell configured with SSS may be a scheduling cell, which can transmit a PDCCH carrying a DL assignment or an UL grant. When there are other cells, the UE may be configured with a rule for M_{DL} CCs. The rule may specify M_{DL} for or based on one or more secondary cells.

As indicated above, FIG. 8 is provided as an example. Other examples may differ from what is described with regard to FIG. 8.

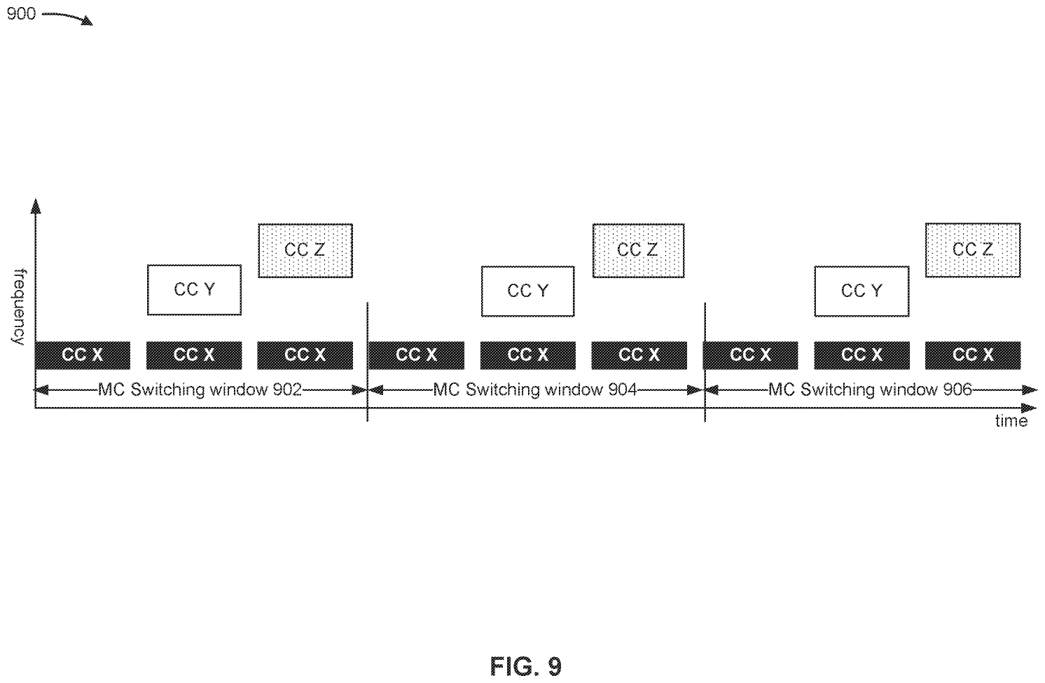

FIG. 9 is a diagram illustrating an example 900 of MC switching windows, in accordance with the present disclosure.

In some aspects, when the UE is in an RRC connected state, there may be an MC switching window during which multiple carriers are used simultaneously and during which carriers are switched periodically. Example 900 shows multiple MC switching windows 902, 904, and 906. The configurations for N_{DL} and N_{UL} may be semi-static. Each MC switching window may have a time duration T_{W,MC}. The semi-static switching of paired DL and UL BWPs may be pre-configured for a FD-capable UE, based at least in part on an S slot of the CCs activated for DL reception or UL transmission within the MC switching window.

In some aspects, the UE may use a non-initial BWP configuration for FD operation in unpaired spectrum. An active DL BWP and its paired UL BWP may be configured on different CCs. The subcarrier spacing (SCS), location, and bandwidth configurations of paired DL and UL BWPs on different CCs may be decoupled. A DL BWP may be paired with an UL BWP with the same BWP ID. However, the RRC parameters of the BWP configuration (e.g., SCS, location, bandwidth) of the DL BWP and its paired UL BWP may be separately configured (decoupled), regardless of whether the BWPs are configured on a TDD band or FDD band. This is different from the BWP configuration rule in NR/5G, where a DL BWP and its paired UL BWP are expected to have the same SCS and be aligned at the same center frequency.

As indicated above, FIG. 9 is provided as an example. Other examples may differ from what is described with regard to FIG. 9.

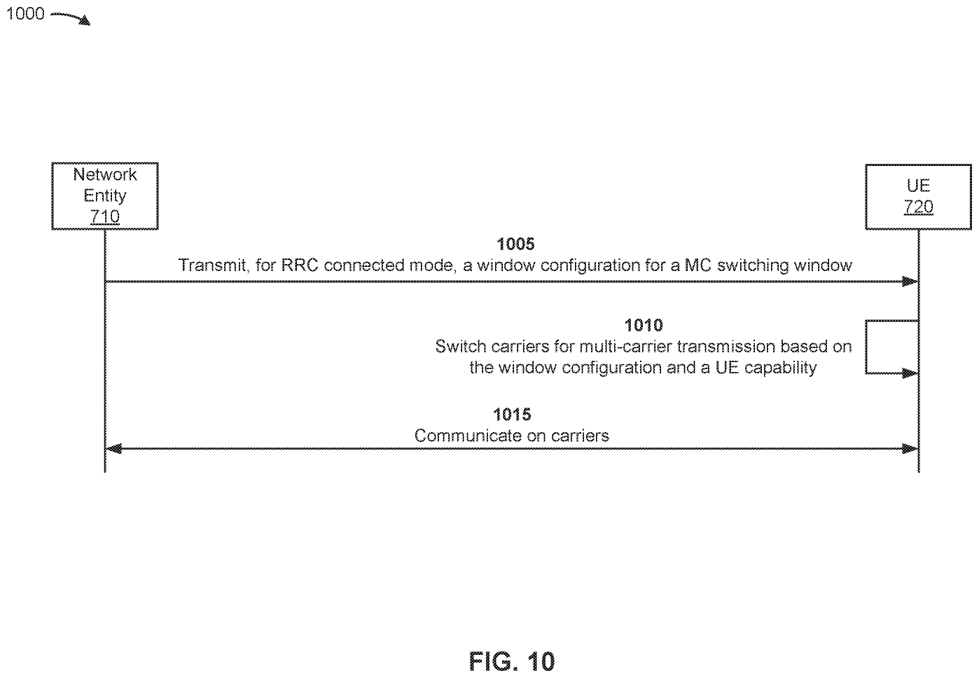

FIG. 10 is a diagram illustrating an example 1000 associated with MC switching, in accordance with the present disclosure.

As shown by reference number 1005, the network entity 710 may transmit, and the UE 720 may receive, a window configuration for an MC switching window. The window configuration may be for when the UE 720 is in an RRC connected mode. In some aspects, the window configuration may indicate a non-initial downlink or uplink BWP on an activated downlink or uplink carrier.

As shown by reference number 1010, the UE 720 may switch carriers for MC transmission, based at least in part on the window configuration and a UE capability. For example, the UE 720 may switch carriers within an amount of time specified for an MC switching window. The UE 720 may not exceed a UE capability for retuning an antenna for a carrier switch. For example, the UE 720 may not exceed a length of a switching gap that the UE 720 expects for a switch. The UE 720 may not exceed the quantity of carriers (UL, DL) over which the UE may 720 may transmit simultaneously. As shown by reference number 1015, the UE 720 may communicate on the carriers.

By using a window configuration, the UE 720 may optimize MC switching and not cause an increase in latency due to a switch for which the UE 720 is not capable.

As indicated above, FIG. 10 is provided as an example. Other examples may differ from what is described with regard to FIG. 10.

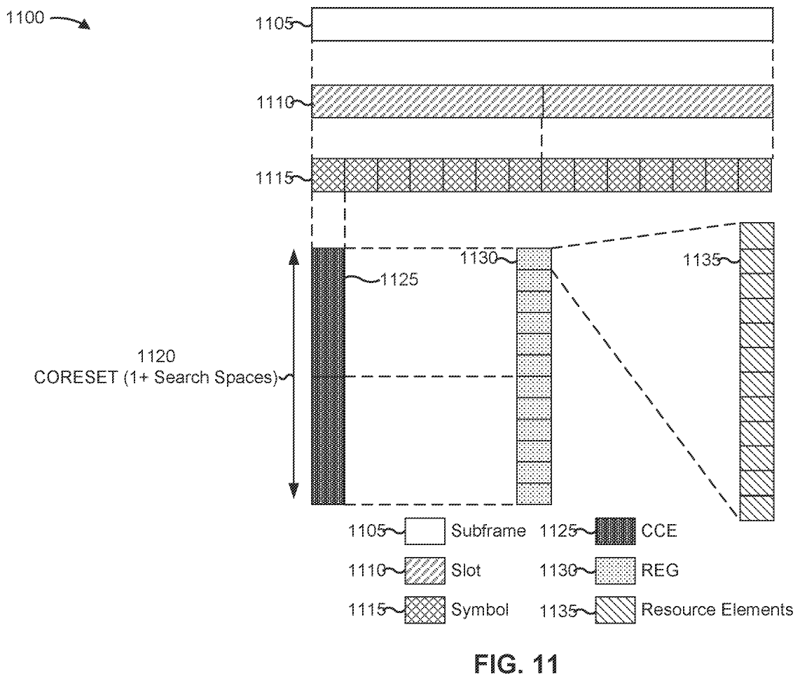

FIG. 11 is a diagram illustrating an example resource structure 1100 for wireless communication, in accordance with the present disclosure. Resource structure 1100 shows an example of various groups of resources described herein. As shown, resource structure 1100 may include a subframe 1105. Subframe 1105 may include multiple slots 1110. While resource structure 1100 is shown as including 2 slots per subframe, a different number of slots may be included in a subframe (e.g., 4 slots, 8slots, 16 slots, 32 slots, or another quantity of slots). In some aspects, different types of transmission time intervals (TTIs) may be used, other than subframes and/or slots. A slot 1110 may include multiple symbols 1115, such as 14 symbols per slot.

The potential control region of a slot 1110 may be referred to as a control resource set (CORESET) 1120 and may be structured to support an efficient use of resources, such as by flexible configuration or reconfiguration of resources of the CORESET 1120 for one or more PDCCHs and/or one or more physical downlink shared channels (PDSCHs). In some aspects, the CORESET 1120 may occupy the first symbol 1115 of a slot 1110, the first two symbols 1115 of a slot 1110, or the first three symbols 1115 of a slot 1110. Thus, a CORESET 1120 may include multiple resource blocks (RBs) in the frequency domain, and either one, two, or three symbols 1115 in the time domain. In 5G, a quantity of resources included in the CORESET 1120 may be flexibly configured, such as by using RRC signaling to indicate a frequency domain region (e.g., a quantity of resource blocks) and/or a time domain region (e.g., a quantity of symbols) for the CORESET 1120.

As illustrated, a symbol 1115 that includes CORESET 1120 may include one or more control channel elements (CCEs) 1125, shown as two CCEs 1125 as an example, that span a portion of the system bandwidth. A CCE 1125 may include DCI that is used to provide control information for wireless communication. A base station may transmit DCI during multiple CCEs 1125 (as shown), where the quantity of CCEs 1125 used for transmission of DCI represents the aggregation level (AL) used by the BS for the transmission of DCI. In FIG. 11, an aggregation level of two is shown as an example, corresponding to two CCEs 1125 in a slot 1110. In some aspects, different aggregation levels may be used, such as 1, 2, 4, 8, 16, or another aggregation level.

Each CCE 1125 may include a fixed quantity of resource element groups (REGs) 1130, shown as 6 REGs 1130, or may include a variable quantity of REGs 1130. In some aspects, the quantity of REGs 1130 included in a CCE 1125 may be specified by a REG bundle size. A REG 1130 may include one resource block, which may include 12 resource elements (REs) 1135 within a symbol 1115. A resource element 1135 may occupy one subcarrier in the frequency domain and one OFDM symbol in the time domain.

A search space may include all possible locations (e.g., in time and/or frequency) where a PDCCH may be located. A CORESET 1120 may include one or more search spaces, such as a UE-specific search space, a group-common search space, and/or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space (SS) set.

A CORESET 1120 may be interleaved or non-interleaved. An interleaved CORESET 1120 may have CCE-to-REG mapping such that adjacent CCEs are mapped to scattered REG bundles in the frequency domain (e.g., adjacent CCEs are not mapped to consecutive REG bundles of the CORESET 1120). A non-interleaved CORESET 1120 may have a CCE-to-REG mapping such that all CCEs are mapped to consecutive REG bundles (e.g., in the frequency domain) of the CORESET 1120.

In some scenarios, the UE 720 may not be configured for searching SS sets when MC switching is involved.

As indicated above, FIG. 11 is provided as an example. Other examples may differ from what is described with respect to FIG. 11.

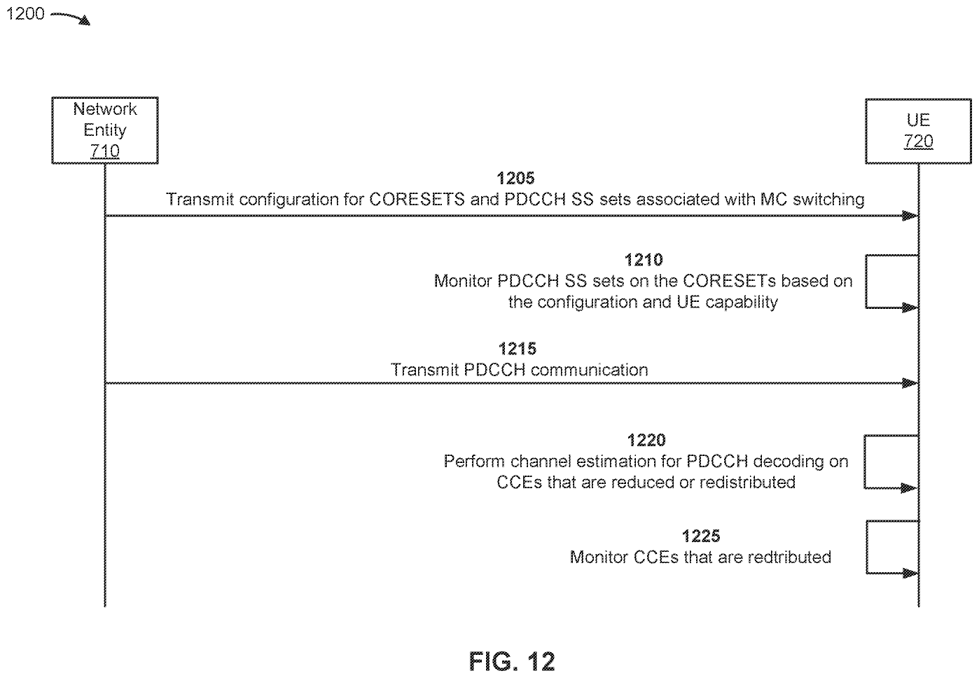

FIG. 12 is a diagram illustrating an example 1100 associated with MC switching, in accordance with the present disclosure.

In some aspects, the UE 720 may be configured for monitoring PDCCH SS sets. A PDCCH search space may include one or more blind detection (BD) CCEs on the PDCCH in which the UE 720 may monitor for control information. As shown by reference number 1205, the network entity 710 may transmit, and the UE 720 may receive, a configuration for CORESETS and PDCCH SS sets associated with MC switching. In some aspects, a common SS (CSS) and a UE-specific SS (USS) may be configured on only one CC within an MC switching window. In some aspects, CSS sets may be associated with Type 0/0A/1/2-PDCCH may be configured on only one CC, while USS sets and the other CSS sets may be configured on multiple CCs activated for DL reception within the MC switching window. In some aspects, CSS sets and USS sets may be configured on multiple CCs activated for DL reception within the MC switching window.

In some aspects, at least a CSS set may be configured on a first downlink carrier within an MC switching window and a USS set may be configured on a second downlink carrier within the MC switching window. In some aspects, the PDCCH SS sets may include a CSS set configured on a downlink carrier within an MC switching window, and a USS set and one or more other CSS sets configured on multiple downlink carriers within the MC switching window.

As shown by reference number 1210, the UE 720 may monitor the PDCCH SS sets on the CORESETS based at least in part on the configuration and the UE capability. As shown by reference number 1215, the network entity 710 may transmit a PDCCH communication in a PDCCH SS set based at least in part on the configuration. The UE 720 may receive the PDCCH communication while monitoring the PDCCH SS sets.

In some aspects, in a slot overlapping with DL switching, the network entity 710 may indicate a reference CC (or a set of reference CCs) associated with active PDCCH monitoring for the UE 720. The UE 720 may not be expect to monitor the PDCCH on the reference CC when the PDCCH monitoring occasions (MOs) (partially) overlap with DL switching of the reference CC. If no reference CC is configured, the UE 720 may skip PDCCH MOs in a slot overlapping with the DL switching.

In some scenarios, the UE may be incapable of CA or DC. In some aspects, the network entity 710 may dynamically schedule the UE. When PDCCH SS sets are configured on multiple CCs activated for DL reception within an MC switching window, different sets of UE capabilities may be specified. As a baseline, only self-scheduling is supported on a CC active for DL reception. As an advanced feature, both self-scheduling and cross-CC scheduling may be supported. Dynamic scheduling may be based at least in part on a length of an MC switching gap (e.g., max (Δ_{UL} Δ_{DL})), and scheduling offsets k0/k1/k2 may be relaxed for MC operation with cross-CC scheduling within the MC switching window.

In some aspects, the BD/CCEs for a UE with limited CA capabilities (e.g., N_{DL}<M_{DL}, N_{UL}<M_{UL}) may be skipped, relaxed (e.g., reduced), or redistributed within an MC switching window. PDCCH MO skipping may involve the UE not being expected to monitor PDCCH in the slot overlapping with DL switching without re-distribution. PDCCH MO relaxation may involve the BD/CCEs being reduced by a scaling factor without re-distribution. The scaling factor may be based at least in part on a quantity of the CCEs, a duration and location of the DL switching gap within the MC switching window, and/or the periodicity of MC switching. PDCCH MO skipping or relaxation with re-distribution may involve the skipped/reduced quantity of CCEs on a slot x being added to another slot y within the same MC switching window. The total quantity of CCEs within the MC switching window may be semi-statically configured.

As shown by reference number 1220, the UE 720 may perform channel estimation for PDCCH decoding on CCEs that are reduced or distributed. This may help to improve SS sets for monitoring when MC switching of multiple carriers is involved. In some aspects, the UE 720 may perform channel estimation for PDCCH decoding on CCEs that are reduced in time or frequency domains based at least in part on an indication for UE power saving, an indication for network energy saving, a quantity of the CCEs, a duration of a downlink switching gap, and/or a location of the downlink switching gap within an MC switching window. Examples of an indication for UE power saving or an indication for network energy saving may include an RRC configuration for discontinuous reception (DRX), PDCCH skipping, CORESET switching, and/or discontinuous transmission (DTX). In some aspects, the UE 720 may perform channel estimation for PDCCH decoding on CCEs that are redistributed in time or frequency domains to other slots within an MC switching window.

As shown by reference number 1225, the UE 720 may monitor CCEs that are redistributed. For example, the UE 720 may monitor CCEs that are redistributed in time or frequency domains within an MC switching window based at least in part on a rule associated with a minimum or average quantity of carriers within the MC switching window and based at least in part on a UE capability for FD operation on paired spectrum, unpaired spectrum, or for CA. The rule may specify that the UE 720 monitors redistributed CCEs if the quantity of carriers satisfies a minimum quantity of carriers. The rule may specify that the UE 720 monitors redistributed CCEs if the quantity of carriers satisfies an average quantity of carriers. In some aspects, the UE 720 may monitor CCEs that are redistributed further based at least in part on numerologies of the multiple carriers or BWPs associated with the MC switching window, an indication for UE power saving, an indication for network energy saving, and/or an indication for priority adaptation or an indication of control resource pre-emption. Examples of indication for priority adaptation or control resource pre-emption may include a slot format change indicated by the network entity 710 and/or muting patterns for interference management indicated by the network entity 710.

In some aspects, a rule proposed for PDCCH monitoring on redistributed CCEs may be determined by the maximum quantity of PDCCH blind decoding attempts within the MC switching window (which may be associated with the quantity of DL and UL carriers activated within the window and the time duration of the window) and the additional network signaling that changes the distribution of PDCCH monitoring across different control resource sets or search space sets (e.g., a pre-emption indication, a priority adaptation, power saving).

In some aspects, if the SCS is the same for the carriers, the UE 720 may follow a slot-based rule for a FD or HD UE incapable of CA/DC or follow a slot-based rule for a FD or HD UE capable of DL reception from N_{DL}≥1 CCs and/or UL transmission on N_{UL}≥1 CCs. In some aspects, the UE 720 may also define a new rule based on the minimum/average number of scheduled CCs within an MC switching window and the UE capability for FD/HD.

In some aspects, if the SCSs of the carriers are different, the UE 720 may follow a slot-based rule for a FD or HD UE incapable of CA/DC, and adopt a lower BD/CCE limit associated with the smaller SCS. For example, if CC1 has a 15 kilohertz (kHz) SCS and CC2 has a 30 kHz SCS, the UE 720 may consider 44 BDs per 1millisecond (ms) for both CCs, which is equivalent to 22 BDs per slot for 30 KHz SCS. In some aspects, the UE 720 may follow a slot-based, SCS-dependent rule for a FD or HD UE capable of DL reception from N_{DL}≥1 CCs and/or UL transmission on N_{UL}≥1 CCs. In some aspects, the UE 720 may define a new rule based at least in part on the minimum/average number of scheduled CCs within an MC switching window and the UE capability for FD/HD, where the scheduled CCs are grouped based at least in part on the actual SCS, or a reference SCS (e.g., minimum SCS of the scheduled CCs).

As indicated above, FIG. 12 is provided as an example. Other examples may differ from what is described with regard to FIG. 12.

FIG. 13 is a diagram illustrating an example process 1300 performed, for example, at a UE or an apparatus of a UE, in accordance with the present disclosure. Example process 1300 is an example where the apparatus or the UE (e.g., UE 120, UE 720) performs operations associated with MC switching.

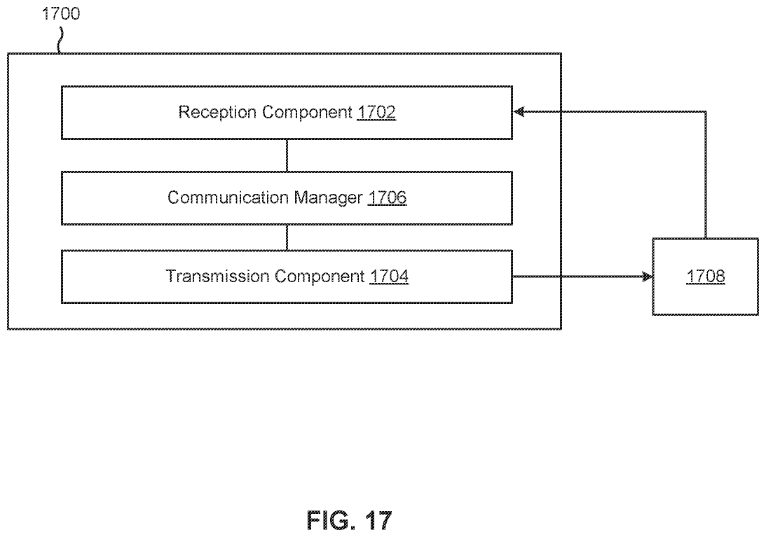

As shown in FIG. 13, in some aspects, process 1300 may include transmitting capability information that indicates a first quantity of carriers that the UE is capable of using simultaneously (block 1310). For example, the UE (e.g., using transmission component 1704 and/or communication manager 1706, depicted in FIG. 17) may transmit capability information that indicates a first quantity of carriers that the UE is capable of using simultaneously, as described above.

As further shown in FIG. 13, in some aspects, process 1300 may include receiving a configuration for a second quantity of activated carriers (block 1320). For example, the UE (e.g., using reception component 1702 and/or communication manager 1706, depicted in FIG. 17) may receive a configuration for a second quantity of activated carriers, as described above.

As further shown in FIG. 13, in some aspects, process 1300 may include switching one or more carriers used for MC transmission based at least in part on the configuration and the capability information (block 1330). For example, the UE (e.g., using communication manager 1706, depicted in FIG. 17) may switch one or more carriers used for MC transmission based at least in part on the configuration and the capability information, as described above.

Process 1300 may include additional aspects, such as any single aspect or any combination of aspects described below and/or in connection with one or more other processes described elsewhere herein.

In a first aspect, the first quantity of carriers and the second quantity of activated carriers are for downlink.

In a second aspect, alone or in combination with the first aspect, the first quantity of carriers and the second quantity of activated carriers are for uplink.

In a third aspect, alone or in combination with one or more of the first and second aspects, the second quantity of activated carriers is greater than the first quantity of carriers.

In a fourth aspect, alone or in combination with one or more of the first through third aspects, the capability information indicates whether the UE supports full duplex operation on paired spectrum, unpaired spectrum, or for carrier aggregation.

In a fifth aspect, alone or in combination with one or more of the first through fourth aspects, process 1300 includes receiving a configuration for an initial downlink BWP and a configuration for an initial uplink BWP on one or more carriers of the quantity of carriers, selecting a pair of an initial downlink BWP and an initial uplink BWP based at least in part on a UE capability and one or more measurements for a downlink reference signal associated with carrier selection or BWP selection, transmitting a random access message in the initial uplink BWP, and monitoring for a random access response message in the initial downlink BWP on one or more carriers selected for a random access procedure.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a UE or an apparatus of a UE, in accordance with the present disclosure. Example process 1400 is an example where the apparatus or the UE (e.g., UE 120, UE 720) performs operations associated with MC switching.

As shown in FIG. 14, in some aspects, process 1400 may include receiving, for an RRC connected mode, a window configuration for an MC switching window during which multiple carriers are used simultaneously and switched periodically (block 1410). For example, the UE (e.g., using reception component 1702 and/or communication manager 1706, depicted in FIG. 17) may receive, for an RRC connected mode, a window configuration for an MC switching window during which multiple carriers are used simultaneously and switched periodically, as described above.

As further shown in FIG. 14, in some aspects, process 1400 may include switching carriers within the MC switching window based at least in part on the window configuration and a UE capability (block 1420). For example, the UE (e.g., using communication manager 1706, depicted in FIG. 17) may switch carriers within the MC switching window based at least in part on the window configuration and a UE capability, as described above.

Process 1400 may include additional aspects, such as any single aspect or any combination of aspects described below and/or in connection with one or more other processes described elsewhere herein.

In a first aspect, the window configuration indicates a non-initial downlink or uplink BWP on an activated downlink or uplink carrier.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, at a UE or an apparatus of a UE, in accordance with the present disclosure. Example process 1500 is an example where the apparatus or the UE (e.g., UE 120, UE 720) performs operations associated with MC switching.

As shown in FIG. 15, in some aspects, process 1500 may include receiving, for an RRC connected mode, a configuration for control resource sets and PDCCH search space sets associated with multiple carriers that are used simultaneously and switched periodically (block 1510). For example, the UE (e.g., using reception component 1702 and/or communication manager 1706, depicted in FIG. 17) may receive, for an RRC connected mode, a configuration for control resource sets and PDCCH search space sets associated with multiple carriers that are used simultaneously and switched periodically, as described above.

As further shown in FIG. 15, in some aspects, process 1500 may include monitoring the PDCCH search space sets on the control resource sets based at least in part on the configuration and a UE capability (block 1520). For example, the UE (e.g., using communication manager 1706, depicted in FIG. 17) may monitor the PDCCH search space sets on the control resource sets based at least in part on the configuration and a UE capability, as described above.

Process 1500 may include additional aspects, such as any single aspect or any combination of aspects described below and/or in connection with one or more other processes described elsewhere herein.

In a first aspect, the PDCCH search space sets include a CSS set configured on a first downlink carrier within an MC switching window and a USS set configured on a second downlink carrier within the MC switching window.

In a second aspect, alone or in combination with the first aspect, the PDCCH search space sets include a CSS set configured on a downlink carrier within an MC switching window, and a USS set and one or more other CSS sets configured on multiple downlink carriers within the MC switching window.

In a third aspect, alone or in combination with one or more of the first and second aspects, the configuration specifies a reference carrier associated with active PDCCH monitoring within an MC switching window.

In a fourth aspect, alone or in combination with one or more of the first through third aspects, different UE capabilities are specified for one or more PDCCH search space sets configured on multiple downlink carriers within an MC switching window.

In a fifth aspect, alone or in combination with one or more of the first through fourth aspects, process 1500 includes performing channel estimation for PDCCH decoding on CCEs that are reduced in time or frequency domains based at least in part on one or more of an indication for UE power saving, an indication for network energy saving, a quantity of the CCEs, a duration of a downlink switching gap, and a location of the downlink switching gap within an MC switching window.

In a sixth aspect, alone or in combination with one or more of the first through fifth aspects, process 1500 includes performing channel estimation for PDCCH decoding on CCEs that are redistributed in time or frequency domains to other slots within an MC switching window.

In a seventh aspect, alone or in combination with one or more of the first through sixth aspects, process 1500 includes monitoring CCEs that are redistributed in time or frequency domains within an MC switching window based at least in part on a rule associated with a minimum or average quantity of carriers within the MC switching window and based at least in part on a UE capability for full duplex operation on paired spectrum, unpaired spectrum, or for carrier aggregation.

In an eighth aspect, alone or in combination with one or more of the first through seventh aspects, monitoring the CCEs that are redistributed includes monitoring the CCEs that are redistributed further based at least in part on one or more of numerologies of the multiple carriers or BWPs associated with the MC switching window.

In a ninth aspect, alone or in combination with one or more of the first through eighth aspects, monitoring the CCEs that are redistributed includes monitoring the CCEs that are redistributed further based at least in part on one or more of an indication for UE power saving or an indication for network energy saving.

In a tenth aspect, alone or in combination with one or more of the first through ninth aspects, monitoring the CCEs that are redistributed includes monitoring the CCES that are redistributed further based at least in part on one or more of an indication for priority adaptation or an indication of control resource pre-emption.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, at a network entity or an apparatus of a network entity, in accordance with the present disclosure. Example process 1600 is an example where the apparatus or the network entity (e.g., network node 110, network entity 710) performs operations associated with MC switching.

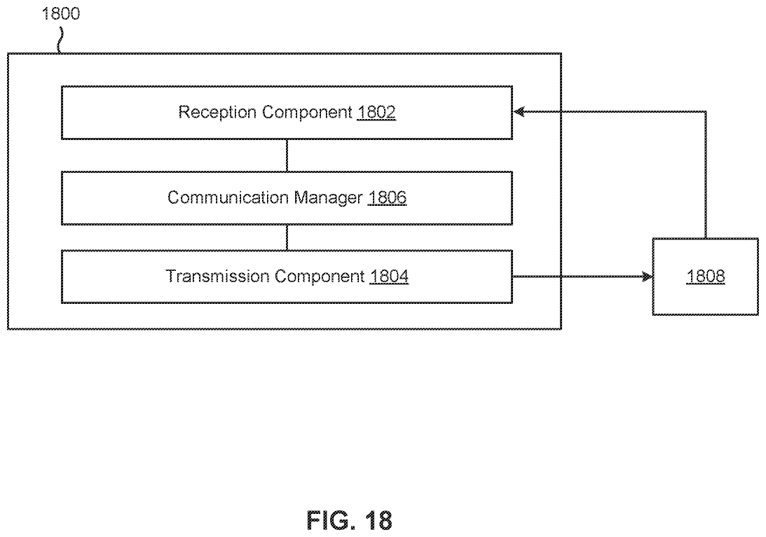

As shown in FIG. 16, in some aspects, process 1600 may include receiving capability information that indicates a first quantity of carriers that a UE is capable of using simultaneously (block 1610). For example, the network entity (e.g., using reception component 1802 and/or communication manager 1806, depicted in FIG. 18) may receive capability information that indicates a first quantity of carriers that a UE is capable of using simultaneously, as described above.

As further shown in FIG. 16, in some aspects, process 1600 may include transmitting a configuration for a second quantity of activated carriers (block 1620). For example, the network entity (e.g., using transmission component 1804 and/or communication manager 1806, depicted in FIG. 18) may transmit a configuration for a second quantity of activated carriers, as described above.

As further shown in FIG. 16, in some aspects, process 1600 may include scheduling communications for multiple carriers based at least in part on the configuration and the capability information (block 1630). For example, the network entity (e.g., using communication manager 1806, depicted in FIG. 18) may schedule communications for multiple carriers based at least in part on the configuration and the capability information, as described above.

Process 1600 may include additional aspects, such as any single aspect or any combination of aspects described below and/or in connection with one or more other processes described elsewhere herein.

In a first aspect, the first quantity of carriers and the second quantity of available carriers are for downlink or uplink.

In a second aspect, alone or in combination with the first aspect, the second quantity of activated carriers is greater than the first quantity of carriers that the UE is capable of using simultaneously.

In a third aspect, alone or in combination with one or more of the first and second aspects, the capability information indicates whether the UE supports full duplex operation on paired spectrum, unpaired spectrum, or for carrier aggregation.

In a fourth aspect, alone or in combination with one or more of the first through third aspects, process 1600 includes transmitting a configuration of an initial downlink BWP and a configuration of an initial uplink BWP on one or more carriers.

In a fifth aspect, alone or in combination with one or more of the first through fourth aspects, the configuration indicates control resource sets and PDCCH search space sets associated with the first quantity of carriers.

In a sixth aspect, alone or in combination with one or more of the first through fifth aspects, process 1600 includes scheduling a communication for the UE based at least in part on one or more of a UE capability, information for UE power saving or network energy saving, information for priority adaptation or control resource pre-emption, or the configuration of control resource sets and PDCCH search space sets within an MC switching window.

In a seventh aspect, alone or in combination with one or more of the first through sixth aspects, the configuration specifies a reference carrier associated with active PDCCH monitoring.

In an eighth aspect, alone or in combination with one or more of the first through seventh aspects, process 1600 includes selecting one or more control resource sets and one or more PDCCH search space sets on multiple carriers within an MC switching window, based at least in part on the capability information.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram of an example apparatus 1700 for wireless communication, in accordance with the present disclosure. The apparatus 1700 may be a UE (e.g., UE 120, UE 720), or a UE may include the apparatus 1700. In some aspects, the apparatus 1700 includes a reception component 1702, a transmission component 1704, and/or a communication manager 1706, which may be in communication with one another (for example, via one or more buses and/or one or more other components). In some aspects, the communication manager 1706 is the communication manager 140 described in connection with FIG. 1. As shown, the apparatus 1700 may communicate with another apparatus 1708, such as a UE or a network node (such as a CU, a DU, an RU, or a base station), using the reception component 1702 and the transmission component 1704.

In some aspects, the apparatus 1700 may be configured to perform one or more operations described herein in connection with FIGS. 1-12. Additionally, or alternatively, the apparatus 1700 may be configured to perform one or more processes described herein, such as process 1300 of FIG. 13, process 1400 of FIG. 14, process 1500 of FIG. 15, or a combination thereof. In some aspects, the apparatus 1700 and/or one or more components shown in FIG. 17 may include one or more components of the UE described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1702 may receive communications, such as reference signals, control information, data communications, or a combination thereof, from the apparatus 1708. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1704 may transmit communications, such as reference signals, control information, data communications, or a combination thereof, to the apparatus 1708. In some aspects, one or more other components of the apparatus 1700 may generate communications and may provide the generated communications to the transmission component 1704 for transmission to the apparatus 1708. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1708. In some aspects, the transmission component 1704 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects. the transmission component 1704 may be co-located with the reception component 1702 in one or more transceivers.

The communication manager 1706 may support operations of the reception component 1702 and/or the transmission component 1704. For example, the communication manager 1706 may receive information associated with configuring reception of communications by the reception component 1702 and/or transmission of communications by the transmission component 1704. Additionally, or alternatively, the communication manager 1706 may generate and/or provide control information to the reception component 1702 and/or the transmission component 1704 to control reception and/or transmission of communications.

In some aspects, the transmission component 1704 may transmit capability information that indicates a first quantity of carriers that the UE is capable of using simultaneously. The reception component 1702 may receive a configuration for a second quantity of activated carriers. The communication manager 1706 may switch one or more carriers used for MC transmission based at least in part on the configuration and the capability information.

The reception component 1702 may receive a configuration for an initial downlink BWP and a configuration for an initial uplink BWP on one or more carriers of the quantity of carriers. The communication manager 1706 may select a pair of an initial downlink BWP and an initial uplink BWP based at least in part on a UE capability and one or more measurements for a downlink reference signal associated with carrier selection or BWP selection. The transmission component 1704 may transmit a random access message in the initial uplink BWP. The communication manager 1706 may monitor for a random access response message in the initial downlink BWP on one or more carriers selected for a random access procedure.

In some aspects, the reception component 1702 may receive, for an RRC connected mode, a window configuration for an MC switching window during which multiple carriers are used simultaneously and switched periodically. The communication manager 1706 may switch carriers within the MC switching window based at least in part on the window configuration and a UE capability.

In some aspects, the reception component 1702 may receive, for an RRC connected mode, a configuration for control resource sets and PDCCH SS sets associated with multiple carriers that are used simultaneously and switched periodically. The communication manager 1706 may monitor the PDCCH search space sets on the control resource sets based at least in part on the configuration and a UE capability.

The communication manager 1706 may perform channel estimation for PDCCH decoding on CCEs that are reduced in time or frequency domains based at least in part on one or more of an indication for UE power saving, an indication for network energy saving, a quantity of the CCEs, a duration of a downlink switching gap, and a location of the downlink switching gap within an MC switching window. The communication manager 1706 may perform channel estimation for PDCCH decoding on control channel elements that are redistributed in time or frequency domains to other slots within an MC switching window. The communication manager 1706 may monitor CCEs that are redistributed in time or frequency domains within an MC switching window based at least in part on a rule associated with a minimum or average quantity of carriers within the MC switching window and based at least in part on a UE capability for full duplex operation on paired spectrum, unpaired spectrum, or for carrier aggregation.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

FIG. 18 is a diagram of an example apparatus 1800 for wireless communication, in accordance with the present disclosure. The apparatus 1800 may be a network entity (e.g., network node 110, network entity 710), or a network entity may include the apparatus 1800. In some aspects, the apparatus 1800 includes a reception component 1802, a transmission component 1804, and/or a communication manager 1806, which may be in communication with one another (for example, via one or more buses and/or one or more other components). In some aspects, the communication manager 1806 is the communication manager 150 described in connection with FIG. 1. As shown, the apparatus 1800 may communicate with another apparatus 1808, such as a UE or a network node (such as a CU, a DU, an RU, or a base station), using the reception component 1802 and the transmission component 1804.

In some aspects, the apparatus 1800 may be configured to perform one or more operations described herein in connection with FIGS. 1-12. Additionally, or alternatively, the apparatus 1800 may be configured to perform one or more processes described herein, such as process 1600 of FIG. 16. In some aspects, the apparatus 1800 and/or one or more components shown in FIG. 18 may include one or more components of the network entity described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1802 may receive communications, such as reference signals, control information, data communications, or a combination thereof, from the apparatus 1808. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, one or more modems, one or more demodulators, one or more MIMO detectors, one or more receive processors, one or more controllers/processors, one or more memories, or a combination thereof, of the network entity described in connection with FIG. 2.

The transmission component 1804 may transmit communications, such as reference signals, control information, data communications, or a combination thereof, to the apparatus 1808. In some aspects, one or more other components of the apparatus 1800 may generate communications and may provide the generated communications to the transmission component 1804 for transmission to the apparatus 1808. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1808. In some aspects, the transmission component 1804 may include one or more antennas, one or more modems, one or more modulators, one or more transmit MIMO processors, one or more transmit processors, one or more controllers/processors, one or more memories, or a combination thereof, of the network entity described in connection with FIG. 2. In some aspects, the transmission component 1804 may be co-located with the reception component 1802 in one or more transceivers.

The communication manager 1806 may support operations of the reception component 1802 and/or the transmission component 1804. For example, the communication manager 1806 may receive information associated with configuring reception of communications by the reception component 1802 and/or transmission of communications by the transmission component 1804. Additionally, or alternatively, the communication manager 1806 may generate and/or provide control information to the reception component 1802 and/or the transmission component 1804 to control reception and/or transmission of communications.

The reception component 1802 may receive capability information that indicates a first quantity of carriers that a UE is capable of using simultaneously. The transmission component 1804 may transmit a configuration for a second quantity of activated carriers. The communication manager 1806 may schedule communications for multiple carriers based at least in part on the configuration and the capability information.

The transmission component 1804 may transmit an indication of an initial downlink BWP for one or more carriers. The communication manager 1806 may schedule a communication for the UE based at least in part on the PDCCH SS. The communication manager 1806 may select one or more PDCCH SS sets on multiple carriers within an MC switching window, based at least in part on the capability information.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

The following provides an overview of some Aspects of the present disclosure:

Aspect 1: A method of wireless communication performed by a user equipment (UE), comprising: transmitting capability information that indicates a first quantity of carriers that the UE is capable of using simultaneously; receiving a configuration for a second quantity of activated carriers; and switching one or more carriers used for multi-carrier transmission based at least in part on the configuration and the capability information.

Aspect 2: The method of Aspect 1, wherein the first quantity of carriers and the second quantity of activated carriers are for downlink.

Aspect 3: The method of any of Aspects 1-2, wherein the first quantity of carriers and the second quantity of activated carriers are for uplink.

Aspect 4: The method of any of Aspects 1-3, wherein the second quantity of activated carriers is greater than the first quantity of carriers.

Aspect 5: The method of any of Aspects 1-4, wherein the capability information indicates whether the UE supports full duplex operation on paired spectrum, unpaired spectrum, or for carrier aggregation.

Aspect 6: The method of any of Aspects 1-5, further comprising: receiving a configuration for an initial downlink bandwidth part (BWP) and a configuration for an initial uplink BWP on one or more carriers of the quantity of carriers; selecting a pair of an initial downlink BWP and an initial uplink BWP based at least in part on a UE capability and one or more measurements for a downlink reference signal associated with carrier selection or BWP selection; transmitting a random access message in the initial uplink BWP; and monitoring for a random access response message in the initial downlink BWP on one or more carriers selected for a random access procedure.

Aspect 7: A method of wireless communication performed by a user equipment (UE), comprising: receiving, for a radio resource control (RRC) connected mode, a window configuration for a multi-carrier switching window during which multiple carriers are used simultaneously and switched periodically; and switching carriers within the multi-carrier switching window based at least in part on the window configuration and a UE capability.

Aspect 8: The method of Aspect 7, wherein the window configuration indicates a non-initial downlink or uplink bandwidth part (BWP) on an activated downlink or uplink carrier.

Aspect 9: A method of wireless communication performed by a user equipment (UE), comprising: receiving, for a radio resource control (RRC) connected mode, a configuration for control resource sets and physical downlink control channel (PDCCH) search space sets associated with multiple carriers that are used simultaneously and switched periodically; and monitoring the PDCCH search space sets on the control resource sets based at least in part on the configuration and a UE capability.

Aspect 10: The method of Aspect 9, wherein the PDCCH search space sets include a common search space set configured on a first downlink carrier within a multi-carrier switching window and a UE-specific search space set configured on a second downlink carrier within the multi-carrier switching window.

Aspect 11: The method of any of Aspects 9-10, wherein the PDCCH search space sets include a common search space (CSS) set configured on a downlink carrier within a multi-carrier switching window, and a UE-specific search space (USS) set and one or more other CSS sets configured on multiple downlink carriers within the multi-carrier switching window.

Aspect 12: The method of any of Aspects 9-11, wherein the configuration specifies a reference carrier associated with active PDCCH monitoring within a multi-carrier switching window.

Aspect 13: The method of any of Aspects 9-12, wherein different UE capabilities are specified for one or more PDCCH search space sets configured on multiple downlink carriers within a multi-carrier switching window.

Aspect 14: The method of any of Aspects 9-13, further comprising performing channel estimation for PDCCH decoding on control channel elements (CCEs) that are reduced in time or frequency domains based at least in part on one or more of an indication for UE power saving, an indication for network energy saving, a quantity of the CCEs, a duration of a downlink switching gap, and a location of the downlink switching gap within a multi-carrier switching window.

Aspect 15: The method of any of Aspects 9-14, further comprising performing channel estimation for PDCCH decoding on control channel elements that are redistributed in time or frequency domains to other slots within a multi-carrier switching window.

Aspect 16: The method of any of Aspects 9-15, further comprising monitoring control channel elements (CCEs) that are redistributed in time or frequency domains within a multi-carrier switching window based at least in part on a rule associated with a minimum or average quantity of carriers within the multi-carrier switching window and based at least in part on a UE capability for full duplex operation on paired spectrum, unpaired spectrum, or for carrier aggregation.

Aspect 17: The method of Aspect 16, wherein monitoring the CCEs that are redistributed includes monitoring the CCEs that are redistributed further based at least in part on one or more of numerologies of the multiple carriers or bandwidth parts associated with the multi-carrier switching window.

Aspect 18: The method of Aspect 16, wherein monitoring the CCEs that are redistributed includes monitoring the CCEs that are redistributed further based at least in part on one or more of an indication for UE power saving or an indication for network energy saving.

Aspect 19: The method of Aspect 16, wherein monitoring the CCEs that are redistributed includes monitoring the CCES that are redistributed further based at least in part on one or more of an indication for priority adaptation or an indication of control resource pre-emption.

Aspect 20: A method of wireless communication performed by a network entity, comprising: receiving capability information that indicates a first quantity of carriers that a user equipment (UE) is capable of using simultaneously; transmitting a configuration for a second quantity of activated carriers; and scheduling communications for multiple carriers based at least in part on the configuration and the capability information.

Aspect 21: The method of Aspect 20, wherein the first quantity of carriers and the second quantity of available carriers are for downlink or uplink.

Aspect 22: The method of any of Aspects 20-21, wherein the second quantity of activated carriers is greater than the first quantity of carriers that the UE is capable of using simultaneously.

Aspect 23: The method of any of Aspects 20-22, wherein the capability information indicates whether the UE supports full duplex operation on paired spectrum, unpaired spectrum, or for carrier aggregation.

Aspect 24: The method of any of Aspects 20-23, further comprising transmitting a configuration of an initial downlink bandwidth part (BWP) and a configuration of an initial uplink BWP on one or more carriers.

Aspect 25: The method of any of Aspects 20-24, wherein the configuration indicates control resource sets and physical downlink control channel (PDCCH) search space sets associated with the first quantity of carriers.

Aspect 26: The method of Aspect 25, further comprising scheduling a communication for the UE based at least in part on the PDCCH search space.

Aspect 27: The method of any of Aspects 20-26, wherein the configuration specifies a reference carrier associated with active PDCCH monitoring.

Aspect 28: The method of any of Aspects 20-27, further comprising selecting one or more PDCCH search space sets on multiple carriers within a multi-carrier switching window, based at least in part on one or more of a UE capability, information for UE power saving or network energy saving, information for priority adaptation or control resource pre-emption, or the configuration of control resource sets and PDCCH search space sets within a multi-carrier switching window.

Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.

Aspect 30: An apparatus for wireless communication at a device, the apparatus comprising one or more memories and one or more processors coupled to the one or more memories, the one or more processors configured to cause the device to perform the method of one or more of Aspects 1-28.

Aspect 31: An apparatus for wireless communication, the apparatus comprising at least one means for performing the method of one or more of Aspects 1-28.

Aspect 32: A non-transitory computer-readable medium storing code for wireless communication, the code comprising instructions executable by one or more processors to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

Aspect 34: A device for wireless communication, the device comprising a processing system that includes one or more processors and one or more memories coupled with the one or more processors, the processing system configured to cause the device to perform the method of one or more of Aspects 1-28.

Aspect 35: An apparatus for wireless communication at a device, the apparatus comprising one or more memories and one or more processors coupled to the one or more memories, the one or more processors individually or collectively configured to cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, individually or collectively configured to cause the UE to:
transmit capability information that indicates a first quantity of carriers that the UE is capable of using simultaneously;
receive a configuration for a second quantity of activated carriers; and
switch one or more carriers used for multi-carrier transmission based at least in part on the configuration and the capability information.

2. The apparatus of claim 1, wherein the first quantity of carriers and the second quantity of activated carriers are for downlink.

3. The apparatus of claim 1, wherein the first quantity of carriers and the second quantity of activated carriers are for uplink.

4. The apparatus of claim 1, wherein the second quantity of activated carriers is greater than the first quantity of carriers.

5. The apparatus of claim 1, wherein the capability information indicates whether the UE supports full duplex operation on paired spectrum, unpaired spectrum, or for carrier aggregation.

6. The apparatus of claim 1, wherein the one or more processors are individually or collectively configured to cause the UE to:
receive a configuration for an initial downlink bandwidth part (BWP) and a configuration for an initial uplink BWP on one or more carriers of the quantity of carriers;
select a pair of an initial downlink BWP and an initial uplink BWP based at least in part on a UE capability and one or more measurements for a downlink reference signal associated with carrier selection or BWP selection;
transmit a random access message in the initial uplink BWP; and
monitor for a random access response message in the initial downlink BWP on one or more carriers selected for a random access procedure.

7. An apparatus for wireless communication at a user equipment (UE), comprising:
one or more memories; and
one or more processors, coupled to the one or more memories, individually or collectively configured to cause the UE to:
receive, for a radio resource control (RRC) connected mode, a window configuration for a multi-carrier switching window during which multiple carriers are used simultaneously and switched periodically; and
switch carriers within the multi-carrier switching window based at least in part on the window configuration and a UE capability.

8. The apparatus of claim 7, wherein the window configuration indicates a non-initial downlink or uplink bandwidth part (BWP) on an activated downlink or uplink carrier.

9. An apparatus for wireless communication at a user equipment (UE), comprising:
one or more memories; and
one or more processors, coupled to the one or more memories, individually or collectively configured to cause the UE to:
receive, for a radio resource control (RRC) connected mode, a configuration for control resource sets and physical downlink control channel (PDCCH) search space sets associated with multiple carriers that are used simultaneously and switched periodically; and
monitor the PDCCH search space sets on the control resource sets based at least in part on the configuration and a UE capability.

10. The apparatus of claim 9, wherein the PDCCH search space sets include a common search space set configured on a first downlink carrier within a multi-carrier switching window and a UE-specific search space set configured on a second downlink carrier within the multi-carrier switching window.

11. The apparatus of claim 9, wherein the PDCCH search space sets include a common search space (CSS) set configured on a downlink carrier within a multi-carrier switching window, and a UE-specific search space (USS) set and one or more other CSS sets configured on multiple downlink carriers within the multi-carrier switching window.

12. The apparatus of claim 9, wherein the configuration specifies a reference carrier associated with active PDCCH monitoring within a multi-carrier switching window.

13. The apparatus of claim 9, wherein different UE capabilities are specified for one or more PDCCH search space sets configured on multiple downlink carriers within a multi-carrier switching window.

14. The apparatus of claim 9, wherein the one or more processors are individually or collectively configured to cause the UE to perform channel estimation for PDCCH decoding on control channel elements (CCEs) that are reduced in time or frequency domains based at least in part on one or more of an indication for UE power saving, an indication for network energy saving, a quantity of the CCEs, a duration of a downlink switching gap, and a location of the downlink switching gap within a multi-carrier switching window.

15. The apparatus of claim 9, wherein the one or more processors are individually or collectively configured to cause the UE to perform channel estimation for PDCCH decoding on control channel elements that are redistributed in time or frequency domains to other slots within a multi-carrier switching window.

16. The apparatus of claim 9, wherein the one or more processors are individually or collectively configured to cause the UE to monitor control channel elements (CCEs) that are redistributed in time or frequency domains within a multi-carrier switching window based at least in part on a rule associated with a minimum or average quantity of carriers within the multi-carrier switching window and based at least in part on a UE capability for full duplex operation on paired spectrum, unpaired spectrum, or for carrier aggregation.

17. The apparatus of claim 16, wherein the one or more processors, to cause the UE to monitor the CCEs that are redistributed, are individually or collectively configured to cause the UE to monitor the CCEs that are redistributed further based at least in part on one or more of numerologies of the multiple carriers or bandwidth parts associated with the multi-carrier switching window.

18. The apparatus of claim 16, wherein the one or more processors, to cause the UE to monitor the CCEs that are redistributed, are individually or collectively configured to cause the UE to monitor the CCEs that are redistributed further based at least in part on one or more of an indication for UE power saving or an indication for network energy saving.

19. The apparatus of claim 16, wherein the one or more processors, to cause the UE to monitor the CCEs that are redistributed, are individually or collectively configured to cause the UE to monitor the CCES that are redistributed further based at least in part on one or more of an indication for priority adaptation or an indication of control resource pre-emption.

20. An apparatus for wireless communication at a network entity, comprising:
one or more memories; and
one or more processors, coupled to the one or more memories, individually or collectively configured to cause the network entity to:
receive capability information that indicates a first quantity of carriers that a user equipment (UE) is capable of using simultaneously;
transmit a configuration for a second quantity of activated carriers; and
schedule communications for multiple carriers based at least in part on the configuration and the capability information.

21. The apparatus of claim 20, wherein the first quantity of carriers and the second quantity of available carriers are for downlink or uplink.

22. The apparatus of claim 20, wherein the second quantity of activated carriers is greater than the first quantity of carriers that the UE is capable of using simultaneously.

23. The apparatus of claim 20, wherein the capability information indicates whether the UE supports full duplex operation on paired spectrum, unpaired spectrum, or for carrier aggregation.

24. The apparatus of claim 20, wherein the one or more processors are individually or collectively configured to cause the network entity to transmit a configuration of an initial downlink bandwidth part (BWP) and a configuration of an initial uplink BWP on one or more carriers.

25. The apparatus of claim 20, wherein the configuration indicates control resource sets and physical downlink control channel (PDCCH) search space sets associated with the first quantity of carriers. 26 The apparatus of claim 25, wherein the one or more processors are individually or collectively configured to cause the network entity to schedule a communication for the UE based at least in part on one or more of a UE capability, information for UE power saving or network energy saving, information for priority adaptation or control resource pre-emption, or the configuration of control resource sets and PDCCH search space sets within a multi-carrier switching window.

27. The apparatus of claim 20, wherein the configuration specifies a reference carrier associated with active PDCCH monitoring.

28. The apparatus of claim 20, wherein the one or more processors are individually or collectively configured to cause the network entity to select one or more control resource sets and one or more PDCCH search space sets on multiple carriers within a multi-carrier switching window, based at least in part on the capability information.
